(19) United States
(12) Patent Application Publication
(10) Pub. No.: US 2025/0339857 A1
(43) Pub. Date: Nov. 6, 2025

(54) MICROFLUIDIC SYSTEM

(71) Applicants: Singapore-MIT Alliance for Research and Technology Centre, Singapore (SG); Nanyang Technological University, Singapore (SG); Massachusetts Institute of Technology, Cambridge, MA (US)

(72) Inventors: Kerwin Zeming KWEK, Singapore (SG); Kwan Zen Nicholas TAN, Singapore (SG); Han Wei HOU, Singapore (SG); Jongyoon HAN, Cambridge, MA (US)

(21) Appl. No.: 18/655,064

(22) Filed: May 3, 2024

(51) Int. Cl. B01L 3/00

(52) U.S. Cl. CPC B01L 3/502761; B01L 2200/0652; B01L 2200/0673; B01L 2300/0663; B01L 2300/0864; B01L 2300/0874; B01L 2300/14

(57) ABSTRACT

Devices and methods for microfluidic parallel sample processing are described. According to an embodiment a microfluidic system for parallel sample processing is provided. The microfluidic system comprises one or more modules, each module comprising: one or more microfluidic chips arranged in a microfluidic chip stack, each of the one or more microfluidic chips comprising a plurality of processing channels, each processing channel comprising an inlet, an outlet, and a processing section, a combined sample inlet fluidically coupled to each processing channel inlet and configured to concatenate a plurality of the processing channel inlets, and a combined sample outlet fluidically coupled to each processing channel outlet and configured to concatenate a plurality of the processing channel outlets.

### TECHNICAL FIELD

The present disclosure relates to microfluidic systems for parallel sample processing, and also relates to microfluidic sorting, and to high-throughput modular microfluidics.

### BACKGROUND

There is a need for scaling of fluid or liquid handling in applications of bioprocessing, chemical processing, or material synthesis. Often these processes, for example sorting of particles or cells, require precision due to micro-scale or nano-scale differences between particles or cells. Microfluidic devices may be designed to perform at this resolution, however, typical microfluidic devices are limited by the liquid handling volume of particle or cell processing, for example in the range of nano- or microliters.

Liquid flowrate may therefore be a bottleneck that hinders the wide scale application of microfluidic technology in fields of medical science, life science, chemistry and biotechnology.

Current methods of biological cell processing often rely on conventional centrifugation techniques, which may require batch processing, and may be inconsistent, laborious, and may result in low recovery.

### SUMMARY OF THE INVENTION

According to a first aspect of the present disclosure a microfluidic system or device for parallel sample processing is provided. The microfluidic system or device comprises one or more modules, each module comprising: one or more microfluidic chips arranged in a microfluidic chip stack, each of the one or more microfluidic chips comprising a plurality of processing channels, each processing channel comprising an inlet, an outlet, and a processing section, a combined sample inlet fluidically coupled to each processing channel inlet and configured to concatenate a plurality of the processing channel inlets, and a combined sample outlet fluidically coupled to each processing channel outlet and configured to concatenate a plurality of the processing channel outlets.

In an embodiment, the microfluidic system and/or the microfluidic chip stack may comprise one or a plurality of microfluidic chips.

In an embodiment, the microfluidic chip stack comprises two or more microfluidic chips, wherein respective processing channel inlets and processing channel outlets of each microfluidic chip are fluidically coupled by respective inlet and outlet through vias traversing the chip stack, wherein the sample inlet is fluidically coupled to the inlet vias and configured to concatenate a plurality of the processing channel inlets, and wherein the sample outlet is fluidically coupled to the outlet vias and configured to concatenate a plurality of the processing channel outlets.

In an embodiment, the sample inlet and/or the sample outlet are formed as a layer of the microfluidic chip stack.

In an embodiment, the layer is a top or uppermost layer of the microfluidic stack.

In an embodiment, the sample inlet and/or the sample outlet are formed as a portion or region of one or more of the microfluidic chips arranged in the microfluidic chip stack.

In an embodiment, the plurality of processing channels each further comprise a respective washing buffer inlet and/or waste outlet.

In an embodiment, the microfluidic system comprises a combined wash inlet configured to concatenate the plurality of processing channel washing buffer inlets, and/or a combined waste outlet configured to concatenate the plurality of processing channel waste outlets.

In an embodiment, the combined wash inlet and/or the combined waste outlet are formed as a layer of the microfluidic chip stack.

In an embodiment, the layer is a top or uppermost layer of the microfluidic stack.

In an embodiment, the combined wash inlet and/or the combined waste outlet are formed as a portion or region of one or more of the microfluidic chips arranged in the microfluidic chip stack.

In an embodiment, the processing channels are arranged in parallel and lengthwise along respective microfluidic chips of the one or more microfluidic chips forming the microfluidic chip stack.

In an embodiment, the processing section of one or more of the plurality of processing channels comprises a particle sorter section.

In an embodiment, the particle sorter sections of the processing channels are cell sorter channels.

In an embodiment, the particle sorter sections of the processing channels comprise a micropillar or nanopillar array.

In an embodiment, the micropillar or nanopillar array comprises an array of concave L-shaped micropillars or nanopillars.

In an embodiment, the micropillars or nanopillars comprise first and second walls at right angles, and a concave third wall linking the first and second walls.

In an embodiment, the micropillars or nanopillars are arranged to provide for deterministic lateral displacement microfluidic sorting of particles traversing the processing channel.

In an embodiment, the microfluidic system comprises a manifold fluidically coupled to the one or more modules, the manifold configured to supply fluid flow and/or pressure to each module of the one or more modules.

In an embodiment, the microfluidic system comprises a microcontroller configured to control the manifold to selectively operate the one or more modules.

In an embodiment, the microfluidic system comprises an interface with user controls to control the microcontroller and selectively operate the one or more modules.

In an embodiment, the microfluidic system comprises a feedback sensor configured to provide sample process information from an output of the one or more modules to the microcontroller.

In an embodiment, the feedback sensor comprises one or more of:
a flow sensor
a flow volume sensor
a pressure sensor
an imaging sensor.

In an embodiment, the sample process information comprises one or more of:
flow rate
flow volume
pressure
particle sorting efficiency
particle sorting yield.

According to a second aspect of the present disclosure, a method of forming a microfluidic system for parallel sample processing is provided. The method, comprises: forming a plurality of processing channels in one or more stacked microfluidic chips, the processing channels comprising an inlet, an outlet, and a processing section, forming a plurality of concatenating sections in either: one or more of the microfluidic chips forming the microfluidic chip stack, and/or a separate concatenating layer of the chip stack, wherein the concatenating sections are configured to fluidly connect inlets and/or outlets of the processing channels.

In an embodiment, the method further comprises forming respective inlet and outlet through vias in each of the one or more stacked microfluidic chips, the through vias fluidically linked in the chip stack such that the through vias traverse the chip stack and fluidically connect the respective inlets and/or outlets of the processing channels.

In an embodiment, the processing channels further comprise one or more washing buffer inlets and/or waste outlets, and wherein the step of forming a plurality of concatenating sections comprises forming concatenating sections in either: one or more of the microfluidic chips forming the microfluidic chip stack, and/or a separate concatenating layer of the chip stack, wherein the concatenating sections are configured to fluidly connect washing buffer inlets and/or waste outlets of the processing channels.

In an embodiment, the processing channels are formed in parallel and lengthwise along respective microfluidic chips of the one or more stacked microfluidic chips.

In an embodiment, the processing section of one or more of the processing channels comprises a particle sorter section.

In an embodiment, the particle sorter sections of the processing channels are formed as cell sorter channels.

In an embodiment, the particle sorter sections of the processing channels comprise a micropillar or nanopillar array.

In an embodiment, the micropillar or nanopillar array comprises an array of concave L-shaped micropillars or nanopillars.

In an embodiment, the micropillars or nanopillars are arranged to provide for deterministic lateral displacement microfluidic sorting of particles traversing the processing channel.

According to a third aspect of the present disclosure a microfluidic parallel processing platform is provided. The microfluidic parallel processing platform comprises: one or a plurality of parallel modules, each module comprising a stack of microfluidic chips, wherein the stack of microfluidic chips comprises a top layer and one or a plurality of bottom layers, wherein the top layer comprises a plurality of flow connectors for concatenating a plurality of fluid inlets into a first single channel, and a plurality of fluid outlets into a second single channel, and wherein each of the bottom layer comprises a plurality of processing channels comprising said plurality of fluid inlets and outlets.

According to a fourth aspect of the present disclosure a multiplexed bioprocessing platform is provided. The multiplexed bioprocessing platform comprises one or a plurality of parallel modules, wherein each module comprises a stack of microfluidic chips, wherein the stack of microfluidic chips comprises a top layer and one or a plurality of bottom layers, wherein the top layer comprises a plurality of flow connectors for concatenating a plurality of fluid inlets into a first single channel, and a second single channel for outlet and waste, respectively, and wherein each of the bottom layer comprises a plurality of sorter channels.

In an embodiment the third or fourth aspects of the present disclosure are combined with any of the embodiments described in the first aspect of the present disclosure.

### BRIEF DESCRIPTION OF THE DRAWINGS

In the following, embodiments of the present invention will be described as non-limiting examples with reference to the accompanying drawings in which:

FIG. 1 illustrates a plurality of microfluidic modules according to an embodiment of the present invention;

FIG. 2a illustrates a top view, side view, and isometric view of a microfluidic module according to an embodiment of the present invention;

FIG. 2b illustrates a side view of a microfluidic module according to an alternative embodiment of the present invention;

FIG. 3 illustrates a top and side view of a microfluidic module according to an alternative embodiment of the present invention;

FIG. 4 shows details of inlets, outlets and channels of a microfluidic chip according to an embodiment of the present invention;

FIG. 5A shows details of a single channel of a microfluidic chip or module according to an embodiment of the present invention;

FIG. 5B shows details of a single channel and a channel structure configuration of a microfluidic module according to an embodiment of the present invention;

FIG. 5C shows details of a single channel and a channel structure configuration of a microfluidic module according to an embodiment of the present invention; and

FIG. 6 illustrates a microfluidic system according to an embodiment of the present invention.

### DETAILED DESCRIPTION

The present disclosure relates to microfluidic systems for parallel sample processing, and also relates to microfluidic sorting, and to high-throughput modular microfluidics. The present disclosure also relates to modularized and scaled high-throughput microfluidics for fluid handling in applications such as biological or chemical processing.

This present disclosure may enable the scaling of fluid handling in applications of bioprocessing or material synthesis. The present disclosure may comprise multifold and modular fluid handling techniques for scalable and high-throughput processing of samples via microfluidic device parallelization, including stacking of microfluidic chips into a module, and scaled operation of one or more modules. In an example embodiment, the sorting modules described herein are operated using an automated controller with graphical user interface and a plug-and-play modular setup.

Current methods of biological cell processing often rely on conventional centrifugation techniques, which may require batch processing, and may be inconsistent, laborious, and may result in low recovery. The present disclosure may comprise a multi-scaled sample processing platform that can efficiently and effectively sort and/or extract particles or cells of interest with a simple interface in a lower turnaround time. This may enable cost savings, and/or scalable and/or continuous processing of biological samples.

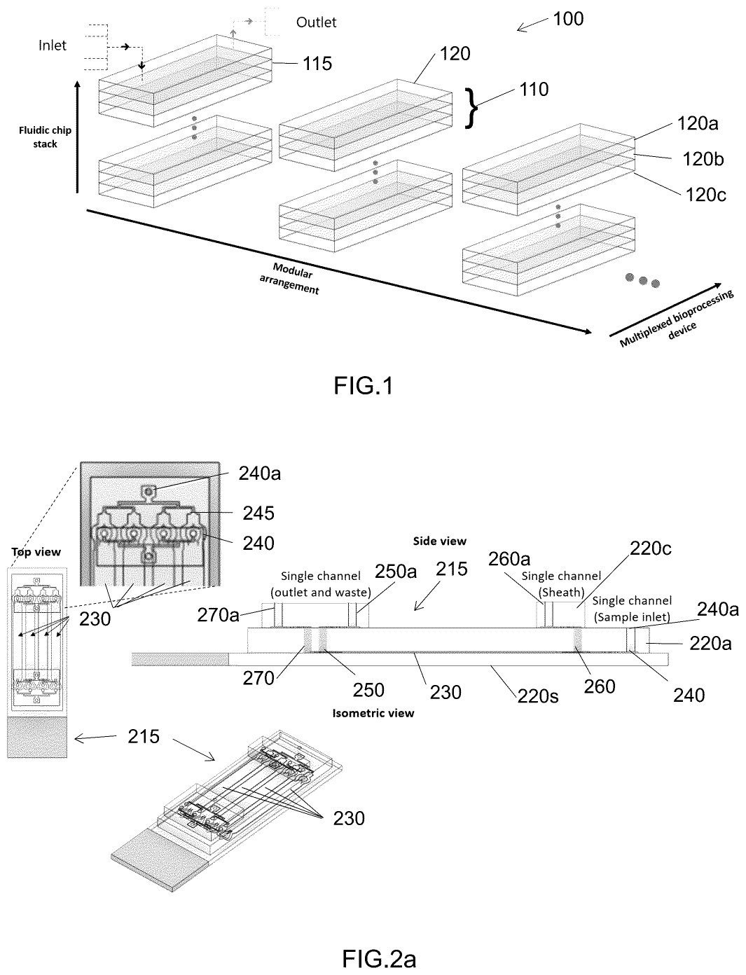

These functional steps will now be described with reference to FIG. 1 to FIG. 6.

FIG. 1 illustrates an example embodiment of a microfluidic system 100 of the present invention. The microfluidic system 100 comprises a plurality of microfluidic chips forming a microfluidic chip stack 110. The microfluidic chip stack forms a module 115, and the microfluidic system 100 may comprise a plurality of modules 115 as shown in FIG. 1. In an example embodiment, the module 115 may comprise a chip stack 110 of a plurality of microfluidic chips, for example microfluidic chips 120a, 120b, 120c, forming a chip stack 110. It will be understood that any number of microfluidic chips 120 may form microfluidic chip stack 110, and similarly any number of modules 115 may be provided to form the microfluidic system 100.

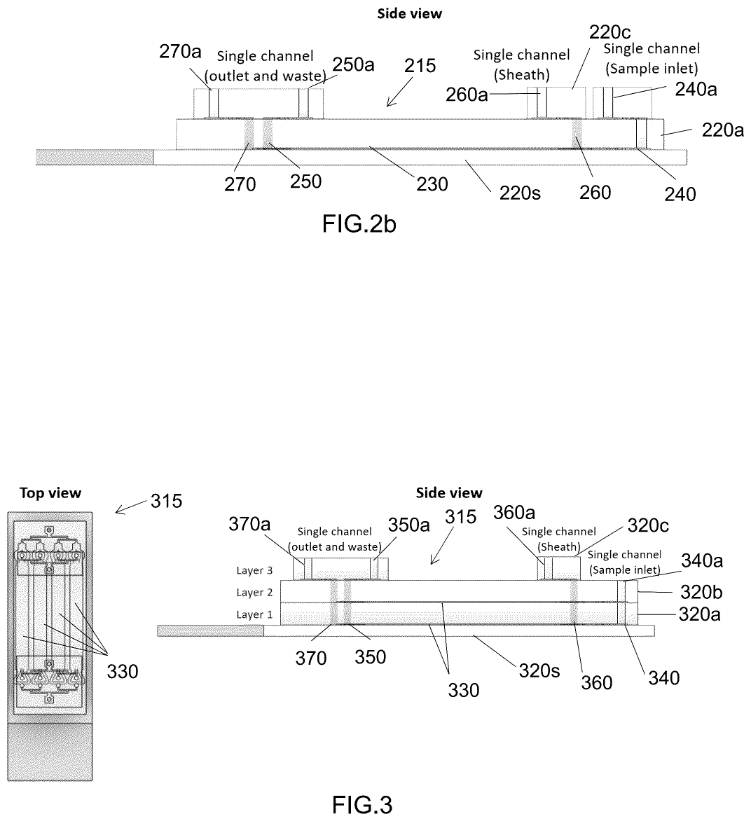

FIG. 2a illustrates a top view, side view, and isometric view of a microfluidic module 215 according to an embodiment of the present invention. In an example embodiment, each microfluidic chip, for example microfluidic chips 120a, 120b, 120c of chip stack 110, as shown in FIG. 1, may comprise a plurality of processing channels 230. The processing channels may be sorting channels, for example parallel sorting channels 230 as shown in FIG. 2a, arranged lengthwise along module 215. The processing channels 230 may comprise processing sections configured for processing a sample as the sample traverses the processing channel.

The example embodiment shown in FIG. 2a comprises a microfluidic chip 220a positioned on a substrate 220s. The microfluidic chip 220a may comprise a plurality of processing channels 230, positioned in parallel and lengthwise along microfluidic chip 220a. In an example embodiment each processing channel 230 may comprise a processing section between an inlet 240 and outlet 250, where the inlet 240 and outlet 250 may comprise through vias 240, 250 extending through a section of the microfluidic chip 220a. In an example embodiment, the through vias 240, 250 may be punched or mechanically created in the microfluidic chip 220a. In an alternative embodiment, the through vias 240, 250 may be created by etching, for example dry or wet etching.

In an example embodiment, the module 215 may comprise a sample inlet and sample outlet section formed as a layer 220c. In an example embodiment (not shown) the layer may comprise a continuous chip layer that overlays the microfluidic chip stack.

In an alternative embodiment, as shown in FIG. 2a, the layer 220c may overlay the inlet 240 and outlet 250 sections of the microfluidic chip stack, which in this embodiment is formed of microfluidic chip 220a.

In an example embodiment the sample inlet 240a and sample outlet 250a may be formed as layer 220c, for example a concatenating layer 220c, and may comprise first and second sections corresponding to the inlet and outlet of the module 210.

In an example embodiment, as shown in FIG. 2a, one or more of the inlet or outlets to the microfluidic stack may be formed on an uppermost microfluidic chip of the stack, for example inlet 240a as shown in FIG. 2a, formed on microfluidic chip 220a. In an alternative embodiment, as shown in FIG. 2b, the sample inlet 240a may comprise an additional layer as described herein, positioned as part of the microfluidic chip stack and formed as layer 220c.

In an example embodiment, concatenating layer 220c may be a complete layer, and may substantially cover the module, and/or microfluidic chip 220a (not shown). Alternatively, as shown in FIGS. 2a and 2b, the layer 220c may be an incomplete layer, with one or more sections positioned toward the relevant inputs and/or outputs of the microfluidic chip 220a. As outlined above, the module may comprise a concatenating layer 220c, complete or incomplete, positioned as a layer 220c of the chip stack forming the module. Alternatively, concatenating may be carried out as described herein with one or more concatenating inlets and/or outlets formed on an uppermost microfluidic chip 220a of the chip stack.

In an example embodiment the inlet 240a may be a combined sample inlet 240a, and may comprise one or a series of channels that concatenate the processing channel inlets 240 of the microfluidic chip 220a. Similarly, in an example embodiment the outlet 250a may be a combined sample outlet 250a, and may comprise one or a series of channels that concatenate the processing channel outlets 250 of the microfluidic chip 220a. In an example embodiment the concatenation may take the form of a series of channels that fluidically couple individual inlets and/or outlets of the processing channels 230.

In an example embodiment, the concatenation may take the form of a series of equal length channels, providing for a substantially equal inlet and outlet flow path for each of the sorting channels 230. The concatenation may take alternative forms as would be understood by the skilled person to enable a concatenated inlet and/or outlet to a plurality of microfluidic channels 230.

In an example embodiment, the concatenation channels may be exemplified by the channels shown in FIG. 2a as inlet channels 245 fluidically connected between a sample inlet 240a and an inlet to each processing channel 240. As outlined above, in one embodiment the concatenating sample inlet 240a and corresponding channels 245 may be positioned or formed on microfluidic chip 220a. However, in an alternative embodiment the concatenating sample inlet 240a and corresponding channels 245 may be positioned or formed on an additional layer or region, positioned in one example as an upper layer of the microfluidic stack 220c as shown in FIG. 2b.

As outlined above, the concatenation of inlet 240a, and/or outlet 250a may include channels or regions to fluidically couple the respective inlets and/or outlets of processing channels 230 such that a sample input to the system proceeds from a single inlet region 240a to the plurality of processing channels 230. In an example embodiment the concatenation may be accomplished with concatenating regions, for example a concatenating inlet region 240a, and concatenating outlet region 250a. The concatenating regions may be configured to allow a sample to proceed through processing channels 230 from a single input or inlet 240a, and/or allow the sample to exit a corresponding outlet 250a after proceeding through processing channels 230.

In an example embodiment, this configuration may provide for parallel processing of samples as described herein.

As outlined above, in one example the concatenating and/or parallel processing may be accomplished by varying the lengths of concatenating channels such that an appropriate quantity of sample may proceed along each of processing channels 230 as required. For example, in one embodiment this may be accomplished by substantially equal length concatenating channels, leading from inlet 240a or to outlet 250a, to allow a sample to proceed at the same rate to each of the plurality of processing channels 230. It will be understood that alternative approaches may be envisaged, for example by varying concatenating and processing channel properties such as length and width to accomplish an appropriate fluid flow through the microfluidic system as required. These properties may be varied to provide for a required throughput of the system, particle sorting rate, parallelization, etc.

In an example embodiment, the processing channels 230, microfluidic chips 120a, 120b, 120c, layer(s) 220c, and/or modules 110 may be formed using a soft lithographic process, for example using a master mold. In an example embodiment, this may comprise forming the processing channels 230, microfluidic chips 120a, 120b, 120c, layer(s) 220c, and/or modules 110 with PDMS, however it will be understood that other elastomers and/or materials could be used to form the microfluidic chips modules, and/or system as described herein.

In an example embodiment, the processing channels 230, microfluidic chips 120a, 120b, 120c, layer(s) 220c, and/or modules 110 may be formed or affixed to a glass substrate, for example substrate 220s. In alternative embodiments, substrate 220s may comprise an elastomer, plastic, or other suitable substrate material for forming microfluidic systems.

An example embodiment of a three-layer stack is illustrated in FIG. 3. In this embodiment the microfluidic module 315 may comprise a substrate layer 320s, a first layer or microfluidic chip 320a and a second layer or microfluidic chip 320b, each layer or microfluidic chip 320a, 320b comprising a plurality of processing channels 330, and forming a microfluidic chip stack. Whilst two chip layers 320a, 320b are shown in FIG. 3, it will be understood that any number of microfluidic chips may be implemented to provide for a microfluidic chip stack with a number of layers as necessary, for example to provide for a required sample throughput.

The microfluidic chips 320a, 320b may comprise a plurality of processing channels 330, positioned in parallel and lengthwise along each of microfluidic chips 320a, 320b. In an example embodiment, each processing channel 330, for example a sorter channel, may comprise an inlet 340 and outlet 350, where the inlet 340 and outlet 350 may comprise through vias extending through a section of each of the microfluidic chips, resulting in a fluidically connected inlet 340 and outlet 350, connected between each of the microfluidic chips 320a, 320b of the microfluidic chip stack.

In an example embodiment, the individual sample inlet 340 of each processing channel 330 of chip 320a may comprise a through via, which may align with through vias of respective processing channel inlets of other chips in the stack, such as chip 320b. In this way, an inlet via may be formed that traverses the chip stack, providing a fluid connection to inputs 340 of the respective processing channels 330. It will be understood that similar through vias may fluidically link the outlets 350 of each microfluidic chip 320a, 320b in the stack. Similar through vias may also link any other inlets and/or outlets to the system as required, such as buffer or sheath inlets 260, and waste outlets 270, as described below.

In an example embodiment, the through vias 340, 350, 360, 370 may be punched or mechanically created in the microfluidic chips 320a, 320b. In an alternative embodiment, the through vias 340, 350, 360, 370 may be created by etching, for example dry or wet etching. A combination of punching and etching may also be used to form the through vias 340, 350, 360, 370. The through vias 340, 350, 360, 370 may be punched or mechanically created or etched before or after forming the microfluidic chip stack. For example, to provide for accurate alignment of through vias on alternating microfluidic chips 320a, 320b, the through vias traversing the chip stack may be punched or etched after the microfluidic chip stack is formed.

As outlined above (for the embodiments in FIGS. 2a and 2b), in the embodiment of FIG. 3 the inlet 340 and outlet 350 of each processing channel may be concatenated to a single inlet 340a and outlet 350a of the microfluidic module. As outlined above, this may be accomplished by providing a concatenating region on one or more of the microfluidic chips 320a, 320b of the microfluidic chip stack, or may be accomplished by providing an additional layer 320c as a concatenating layer or region providing inlets 340a, and outlets 350a. As outlined above in regard to FIGS. 2a and 2b, the concatenating may be accomplished with one or more channels fluidically linking sample inlet 340a with each processing channel 330 through inlet 340, and correspondingly for outlet 350a by fluidically linking each processing channel 330 to outlet 350a through channel outlets 350. In an example embodiment, the inlet 340a and outlet 340b may fluidically link to the through vias traversing the chip stack as set out above.

In an example embodiment, the module as shown in FIG. 2a, 2b, and 3 may comprise additional inlets and outlets to channels 230/330 as required. For example, the microfluidic chips may comprise a buffer or sheath inlet 260, and a waste outlet 270.

As outlined above for sample inlet 240/340 and sample outlet 250/350 (as shown in FIG. 2a, 2b and 3), any additional inputs or outputs of the system, such as buffer inlet 260/360 and waste outlet 270/370, may similarly be concatenated by through vias traversing the chip stack, and/or concatenating regions providing for fluidic connection between a single inlet and/or outlet and the plurality of processing channels 230/330.

In an example embodiment the buffer or sheath inlet 260/360 may comprise a single inlet positioned as forming, or forming part of, a third layer 220c, 320c of the microfluidic chip stack, and providing for fluid connection to a plurality of buffer or sheath inlets to processing channels 230/330.

Similarly, waste outlet 270/370 may comprise a single outlet positioned as forming, or forming part of, a third layer 220c, 320c of the microfluidic chip stack, and providing for fluid connection to a plurality of buffer or sheath inlets to processing channels 230/330.

As outlined above, the buffer or sheath inlet 260 and/or the waste outlet 270 may be fluidically linked by through vias traversing the chip stack, to facilitate concatenation of the buffer inlet 260 and/or waste outlet 270 of each of the plurality of processing channels 230 to a single inlet and/or outlet.

The example embodiment shown in FIG. 3 includes four processing channels 330 per microfluidic chip 320a, 320b of the microfluidic chip stack. It would be understood that this equates to 8 total processing channels in the module 315. As outlined above, the inlet 340 and outlet 350 of each processing channel may comprise respective through vias traversing the chip stack, as shown in FIG. 3 at 340, and 350. In an example embodiment, the module 315 may include 4 inlet vias 340, with each inlet via fluidically linking respective processing channels 330 of the first chip 320a, and the second chip 320b. Similarly, the module 315 may include respective through vias traversing the chip stack and fluidically linking respective outlets 350, buffer inlets 360, and waste outlets 370 of the microfluidic chips 320a, 320b of the stack. In an example, there may also be 4 of each respective through via, however it will be understood that other configurations may be provided to fluidically link the respective channel inlets and outlets as required.

In an example embodiment, the through vias forming inlets 340 and fluidically coupling respective processing channels 330 of each chip 320a, 320b in the stack may be concatenated as described herein. In this way, the inlet of 8 processing channels of module 315 may connect to 4 through vias, which may in turn be concatenated by sample inlet 340a to form a single inlet to said 8 processing channels. It would be understood that respective through vias may be provided for additional microfluidic chips provided in the stack, meaning the concatenation of any number of processing channels is envisaged. In an example, the number of processing channels in the module 315 may be increased by introducing additional processing channels on each chip of the stack, and by introducing additional chips to the stack, which may also provide for respective through vias linking respective inlets of each processing channel. A similar arrangement may be provided for each of the outlets 250/350 with sample outlet 250a/350a, and/or buffer inlets 260/360 and waste outlets 270/370 as described herein.

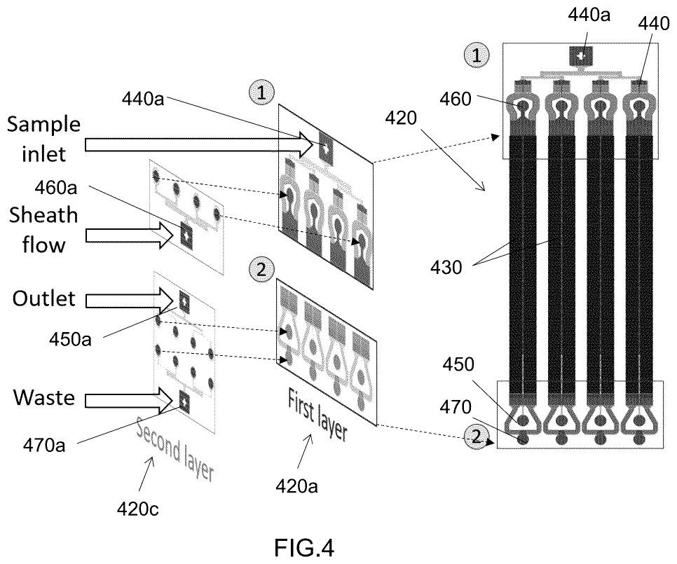

FIG. 4 illustrates an example embodiment of a microfluidic chip 420, for example microfluidic chips forming layer 220a, 330a and/or 330b as shown in FIG. 2a, 2b, and 3. In an example embodiment, the microfluidic chip 420 includes a plurality of processing channels 430, in this case 4 processing channels. Each processing channel may comprise a sample inlet 440, a sample outlet 450, a buffer inlet 460, and a waste outlet 470.

In an example embodiment, the system as described herein may comprise one or a number of microfluidic chips 420, which may be arranged in a microfluidic chip stack 110 as described herein. In an example embodiment, the individual sample inlet 440 of each processing channel 430 may comprise a through via, which may align with through vias of other chips 120, 420 in the stack forming a via traversing the chip stack. This configuration may allow a sample to be input to the system as described herein.

In an example embodiment, the microfluidic chip 420 may comprise a concatenation region, such as sample input 440a, to fluidically link the individual inputs 440 of respective processing channels 430. In some embodiments, the concatenating region may be formed on or to microfluidic chip 420, as a single layer making up microfluidic stack 110. In alternative embodiments, the concatenation region may comprise input 440a formed as an additional layer in the microfluidic stack. In either embodiment, the concatenation region may comprise a number of fluidically linked channels as described herein, linking a single sample inlet 440a with individual sample inputs 440 to each respective processing channel 430. As described herein, in an example embodiment the concatenating channels may comprise equal length channels to provide for equal length flow-paths to each of processing channels 430 via a single inlet 440a. Alternatively, processing channels 430 and/or concatenating channels or regions (e.g. sample input 440a), may have properties that are varied to provide for the required flow conditions. For example, varying channel length and width to provide for a required flow rate or processing rate.

In an example embodiment, the microfluidic chip 420 may also comprise outlet 450, buffer inlet 460 and/or waste outlet 470. As outlined above, each may comprise a concatenation region, such as sample outlet 450a (or buffer inlet 460a, waste outlet 470a), to fluidically link the individual outputs 450 (or buffer inlets 460, waste outlets 470) of respective processing channels 430. In some embodiments, the concatenating region(s) may be formed on or to microfluidic chip 420, as a single layer making up microfluidic stack 110. In alternative embodiments, the concatenation region(s) may comprise output 450a (or buffer inlet 460a, waste outlet 470a), formed as an additional layer(s) in the microfluidic stack as described above in relation to FIGS. 2a and 2b.

As described herein, the various sample inlets and outlets, such as inlets 440a, outlet 450a, buffer inlet 460a, and waste outlet 470a may link to respective through vias traversing the chip stack, with a through via provided for each inlet 440, outlet 450, buffer inlet 460 and/or waste outlet 470 of each of the plurality of processing channels 430 disposed on the chip 420. In this way, the concatenation of processing channels 420 may be accomplished to each processing channel 430 on each chip 420 making up the chip stack.

FIG. 4 also shows first layer 420a, and second layer 420c. As illustrated in FIG. 4, first layer 420a may comprise concatenating regions 1 and 2, which may be formed as, or formed as part of, microfluidic chip 420 forming at least a first layer of a microfluidic chip stack. In alternative embodiments, first layer 420a may be formed as a separate layer, and may be formed as a continuous layer, or discontinuous layer, as described above in regard to FIGS. 2a and 2b. First layer 420a may comprise one or more inputs 440a, and/or outputs (e.g. 450a), and may comprise concatenating regions and/or channels to provide for concatenation and to allow a single input 440a to fluidically couple to inlets 440 of microfluidic chip 420 and/or processing channels 430.

In this way, a combined sample inlet may be formed, that is fluidically coupled to each processing channel 430, and concatenates the plurality of inputs 440 of processing channels 430 to a single input 440a.

Second layer 420c may be formed as a separate layer, and may be formed as a continuous layer, or discontinuous layer, as described above in regard to FIGS. 2a and 2b. As shown by dashed arrows in FIG. 4, second layer 420c may comprise through vias or fluidic connections linking to first layer 420a (which may be formed as a separate layer, or formed on microfluidic chip 420). In this way, a single outlet 450a (and/or buffer inlet 460a, waste outlet 470a), may be a concatenating outlet/inlet, and may fluidically connect to one or more outlets and/or inlets, such as outlet 450 (or buffer inlet 460, waste outlet 470), of processing channels 430 making up microfluidic chip 420.

In this way, a combined sample outlet may be formed, that is fluidically coupled to each processing channel 430, and concatenates the plurality of outputs 450 of each processing channel 430 to a single combined or concatenated output 450a. A similar arrangement may be provided for additional inputs and/or outputs to the microfluidic chip 420 or module, for example combined or concatenated buffer inlet 460a may concatenate buffer inlets 460 of each processing channel 430, and combined or concatenated waste outlet 470a may concatenate waste outlets 470 of each processing channel 430.

Whilst one example is provided in FIG. 4 of a microfluidic chip 420, first layer 420a, and second layer 420c, it will be understood that any number of layers may be included to provide for the required input and/or output combination or concatenation as described herein. For example, each of the inputs and/or outputs described may be formed on separate layers, or the same layer, and may be formed as part of microfluidic chip 420, or as separate layers making up the microfluidic stack or module.

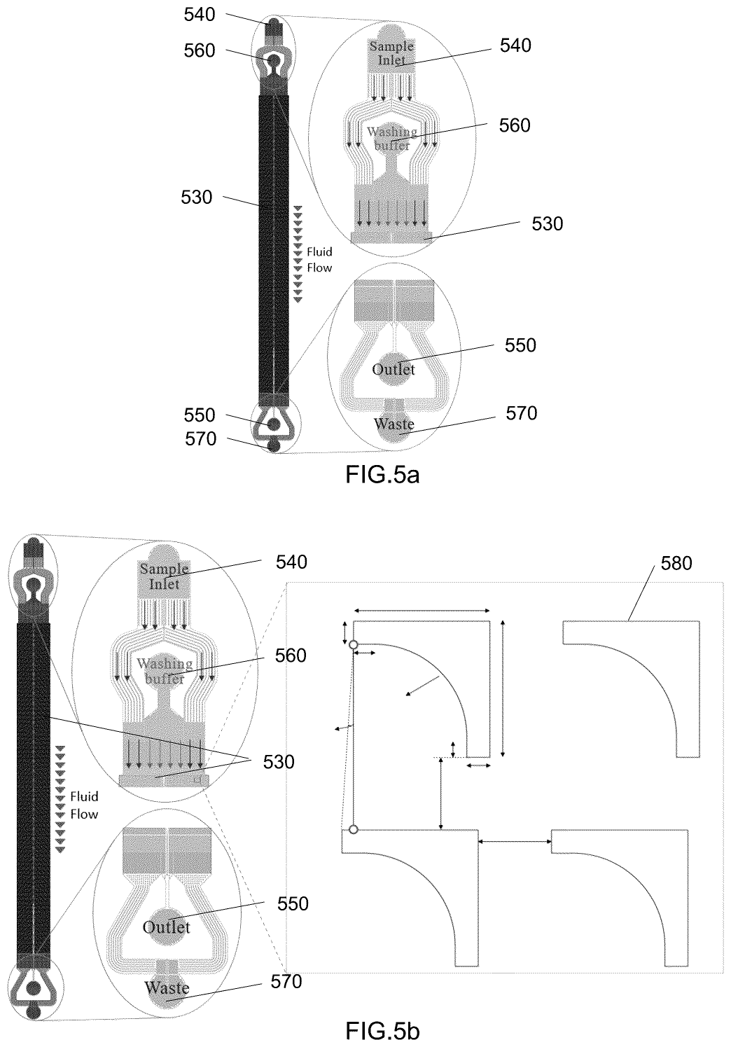

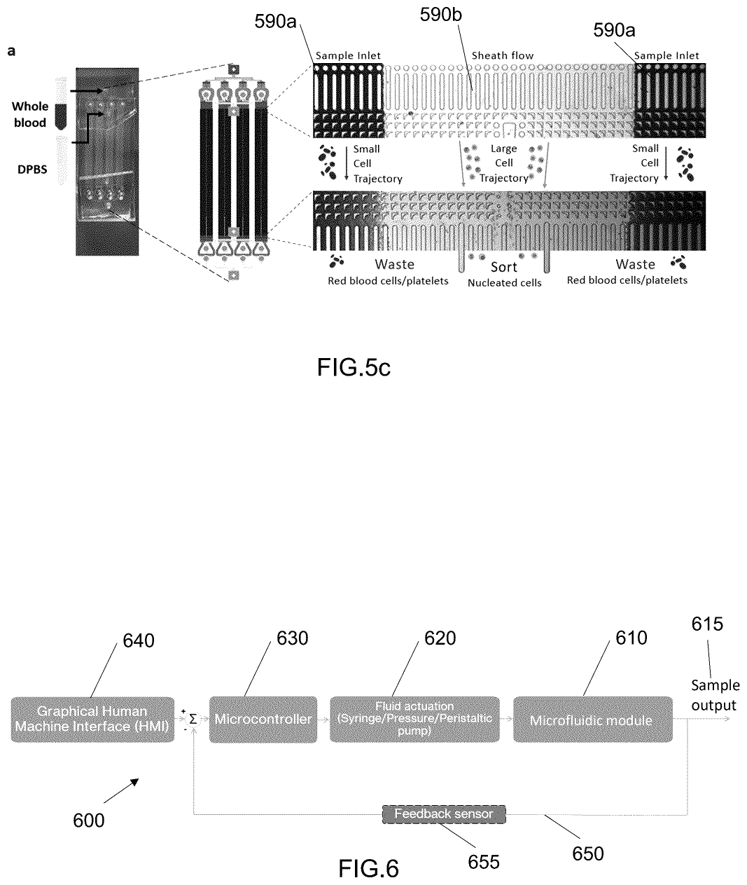

FIG. 5a illustrates an example embodiment of a processing channel, such as processing channels 230, 330, 430 as described herein. In FIG. 5a, processing channel 530 may comprise a single processing channel, which may be arranged along with a plurality of processing channels in a microfluidic chip as described herein. The processing channel 530 may comprise a sample inlet 540, and outlet 550. The channel 530 may also comprise a washing buffer inlet 560, and waste outlet 570. As described herein, the inlets and outlets may be fluidically connected to concatenating or combining regions or layers.

In an example embodiment, the processing channel 530 may comprise a processing section, for example a sorting channel, configured to sort particles traversing the channel as part of a fluid suspension. In an example embodiment, a sample may be introduced to the sample inlet 540, for example via a concatenating region as described herein, and configured to introduced a sample in parallel to a number of processing channels 530 for parallel processing. In an example embodiment, the processing channel 530 may comprise a processing section, sorting section, or channel containing distributed nanostructures or microstructures in an array, which may be configured to interact with particles of various sizes suspended within a fluid traversing the channel, thereby leading to a sorting of the particles by size or other dimension or property, for example mass, buoyancy, etc. In an example embodiment the sorter channels 530 may comprise a plurality of nanopillars or micropillars arranged such that particles traversing the channel may be sorted, for example by particle size.

In an example embodiment as shown in FIG. 5b, the nanostructures or microstructures may comprise an array of concave L-shaped micropillars, such as micropillars 580. In an example embodiment, the L-shaped pillar array may accomplish sorting via deterministic lateral displacement (DLD) in the microfluidic channel as described herein. The L-shaped pillar array may be of the form as described in “Scalable mesenchymal stem cell enrichment from bone marrow aspirate using deterministic lateral displacement (DLD) microfluidic sorting”, Lab Chip, 2023, 23, 4313-4323, which is incorporated herein by reference in its entirety.

The L-shaped micropillars shown in FIG. 5b may be configured in dimension and/or separation between adjacent pillars to accomplish particle sorting. For example, the micropillars 580 may comprise first and second sides at right angles, and a third concave side forming the L-shaped pillar. Dimensions of the sides, concave radius, separation between pillars, and/or pillar orientation may be varied to achieve a particular sorting of particles suspended in a fluid as the fluid flows over or across a region comprising the L-pillars 580.

In the example of FIG. 5b, a sample inlet 540 may be configured such that the sample flows along outer sides of channel 530. Similarly, a washing buffer inlet 560 may be configured such that a washing buffer flows along an inner or central region of the channel 530. This configuration, where a central buffer flow may be sandwiched by outer sample co-flows, may provide for a sorting of particles when combined with the nanopillar or micropillar array as described herein.

In an example embodiment as shown in FIG. 5c, a plurality of nanopillars or micropillars may be arranged in processing channel 530, which may be a sorter channel, such that particles traversing the channel may be sorted, for example by particle size. As shown in FIG. 5c, smaller particles may proceed along outer region(s) 590a of the sorter channel 530, and larger particles may proceed along inner region(s) 590b of the sorter channel 530. This may be accomplished via the arrangement and size of the nanostructures or microstructures as described herein, as well as the flow paths of the sample inlet and buffer, which may lead to a separating and sorting of particles, for example via DLD.

Whilst the above embodiment of FIG. 5a, 5b and 5c has been described with regard to L-shaped concave micropillars, it will be understood that any other structural shape and/or size of micropillar or nanopillar may be employed to provide for a sorting of particles or cells traversing a processing channel 530 as described herein. In an example embodiment, the nanopillar or micropillar array may comprise a uniform array of identical or similar size nanopillars or micropillars. In an alternative embodiment, the nanopillar or micropillar array may comprise an array formed of varying size nanopillars or micropillars.

Similarly, whilst an arrangement is described in FIG. 5a, 5b and 5c where a sample traverses an outer side of the channel, sandwiching a buffer flow towards a center of the channel, it will be understood that any configuration of sample and/or buffer flow may be envisaged to provide for a sorting of particles or cells traversing processing channel 530.

As described herein, DLD may be a continuous particle separation or sorting method using an asymmetric array of micro-posts or micropillars in microchannel or microfluidic channel. In an example embodiment, a critical diameter of the system may comprise the diameter at which particles larger than the critical diameter will undergo a lateral drift, whereas particles smaller than the critical diameter may travel along an original trajectory. In this way, particle sorting and/or separation may be accomplished as described herein.

In an example embodiment, the L-shaped cross section micropillars as described herein may comprise pillars with a period of 45, and first and second sides of ˜29 μm. The pillars may comprise a separation between individual pillars of ˜16 μm. A separation or displacement angle between the individual pillars may be ˜3.18°. A third side of the nanopillars may comprise a concave arc comprising a radius of 19.5 μm. The concave arc may comprise substantially flat portions at first and second ends of the arc meeting the first and second sides. The concave arc may comprise flat sides of 4.5 μm, and may comprise end widths of 5 μm.

The micropillar array may comprise parameters as set out in the table below, and using the formula below, the critical diameter may be calculated as ˜5.6 μm. In an example embodiment, the critical diameter may comprise the diameter at which particles larger than the critical diameter will undergo a lateral drift, whereas particles smaller than the critical diameter may travel along an original trajectory. In this way, particle sorting may be accomplished as described herein.

Micropillar parameters

| Period (N) | 45 | |
|---|---|---|
| Gap size (G) | 16 | μm |
| Angle ( ) | 3.18° | |
| Critical diameter (Dc) | 5.6 | μm |

$${D}_{c} = 1.4 {G ( tan θ )}^{0.48}$$

Whilst the above embodiment has been described with regard to L-shaped concave micropillars, it will be understood that any other structural shape may be employed to provide for a specific critical diameter required for sorting of particles or cells traversing a processing channel as described herein.

Embodiments of the present invention may be operable or configured to process one or more of the following example biological or biomanufacturing processes:
Leukapheresis in the CAR manufacturing pipeline to replace centrifugation for more efficient cell harvest/enrichment
Extraction of Stem Cells from Bone Marrow
Purification of healthy RBCs in blood bank
Extraction of stem cells from cord blood
Extraction of stem cells from bone marrow
By-product isolation from fermentation in yeast/bacteria
High-throughput Virus isolation

Embodiments of the present invention may be operable or configured to process one or more of the following example chemical processing or synthesis operations:
High-throughput synthesis of nanoparticles
Droplet/emulsion drug manufacturing at scale

FIG. 6 illustrates an example embodiment of a microfluidic system 600. In an example embodiment, the system may comprise one or more microfluidic modules 610, such as those described as 110 in FIG. 1. In an example embodiment, the one or more microfluidic modules may comprise a high throughput bioprocessing platform, such as a cell sorting platform as described herein and shown in FIG. 6, however it will be understood that microfluidic module 610 could be any suitable module, such as a processing or sorting module as described herein.

In an example embodiment, the one or more microfluidic modules 610 may receive sample, buffer, and other inputs and/or outputs as required via a fluid actuation unit 620. This fluid actuation unit 620 may comprise a manifold fluidically coupled to the one or more modules. The manifold may be configured to control operation of each of the one or more modules, for example by providing fluid flow and/or pressure to one or more of the microfluidic modules, chip stacks, concatenation input/outputs and/or processing channels as described herein.

In an example embodiment, fluid actuation unit 620 may comprise one or more syringes, pressure pumps, and/or peristatic pumps, and may provide input and/or output of fluid as required. The fluid actuation unit 620 may comprise any other microfluidic system fluid handling and control apparatus as required for pumping, providing pressure, providing sample, and/or providing buffer. In an example embodiment, the microfluidic modules 610 may be one-way modules or channels, and may be fluidly connected to a sample output and/or a waste output. In this way, the fluid actuation unit 620 may provide fluid flow, for example a sample flow and/or a buffer flow, and the one or more modules 610 may output sorted samples, and/or waste, to suitable receptacles or for further processing.

In an example embodiment, the fluid actuation unit 620 may be controlled by a controller, such as microcontroller 630. In one example, syringes, pressure pumps, and/or peristatic pumps may be controlled by the microcontroller 630, which may result in control of the pressure and/or flow of sample and/or buffer through the one or more microfluidic modules.

In an example embodiment, the microfluidic system 600 may comprise an interface 640 for control of microfluidic system 600. For example, the interface 640 may comprise a graphical human machine interface (HMI), or graphical user interface (GUI). The interface 640 may provide the ability for a user operating the microfluidic system 600 to control system parameters as described herein, which may include flow and pressure rates of the one or more microfluidic modules 610.

In an example embodiment, microfluidic system 600 may comprise a feedback loop 650, which may comprise one or more feedback sensors 655 configured to feedback parameters of a sample output 615 of the one or more microfluidic modules to the microcontroller and/or HMI. In an example embodiment, the feedback loop 650 may comprise feedback sensors to measures changes in flowrate, pressure, and/or sorting efficiencies or output. In this way, the system may provide feedback to a user on the sorting of a particular sample that is achieved at sample output 615 with current parameter settings. In an example embodiment, the feedback loop 650 may also provide for a calibration of the microfluidic system 600, for example calibrated for a particular particle sorting and/or recovery rate at sample output 615 as required. In an example, this may be achieved by feeding back the sample output 615 of the one or more microfluidic modules 610 to the microcontroller 630 and/or HMI 640, and varying operating parameters to achieve a required sample output 615, for example particle sorting efficiency or yield.

In an example embodiment, the one or more microfluidic modules 620 may output via one or more sensors 655. The sensors may sense any parameter of the sample output 615 of the microfluidic system, for example, the sensor(s) 655 may sense an output flow rate of a sample output 615 and/or a waste output (not shown), and adjust a flow rate via the fluid actuation unit 620. The sensors 655 may also sense a pressure of the sample output 615 and/or waste (not shown), and adjust the fluid actuation unit 620 to achieve a particular pressure. In an example embodiment, the sensors 655 may comprise particle sensors, such as an optical and/or imaging sensor, able to identify a sorting rate or efficiency or yield of the sample output 615. In an example embodiment, the pressure and/or flow rate may affect the sorting efficiency of the sample, and pressure, flow rate, and/or other parameters may be adjusted as a result of feedback from the particle sensor to achieve a particular sorting efficiency and/or yield at the sample output 615. In this way, the system may utilize feedback loop 650 from sensors 655 to provide feedback information to microcontroller 630 and/or HMI 640, to achieve a particular sample processing or sorting yield or efficiency at sample output 615 as required.

In an example embodiment, a microfluidic parallel processing platform may be provided, such as that disclosed herein as microfluidic system 100 in FIG. 1 or 600 in FIG. 6. The microfluidic parallel processing platform may comprise one or a plurality of parallel modules, such as modules 115 formed of microfluidic chip stack 110 as described in relation to FIG. 1. Each module may comprise a stack of microfluidic chips 110, where the stack of microfluidic chips 110 may comprise a top layer, such as layer 220c as described in relation to FIG. 2a and one or a plurality of bottom layers, such as microfluidic chip layer 220a as described in relation to FIG. 2a. In an example embodiment, the top layer 220c may comprise a plurality of flow connectors, such as sample inlet 240a, outlet 250a, buffer inlet 260a, and/or waste outlet 270a, for concatenating a plurality of fluid inlets, such as inlets 240, into a first single channel 240a, and a plurality of fluid outlets, for example outlets 250, into a second single channel 250a. In an example embodiment, each of the bottom layer(s) comprises a plurality of processing channels 230.

In an example embodiment, a multiplexed bioprocessing platform may be provided. The multiplexed bioprocessing platform may comprise one or a plurality of parallel modules, such as modules 115 as described in relation to FIG. 1, wherein each module 115 comprises a stack 110 of microfluidic chips, such as those described in relation to FIG. 3 as microfluidic chips 320a, 320b. In an example embodiment, the stack 110 of microfluidic chips 320a, 320b comprises a top layer 320c, and one or a plurality of bottom layers, 320a, 320b. In an example embodiment, the top layer 320c comprises a plurality of flow connectors, such as inputs and/or outputs 340a, 350a, 360a, 370a, for concatenating a plurality of fluid inlets or outlets 340, 350, 360, 370 into one or more of a first single channel, for example as an inlet channel 340a, and/or a second or more single channel(s), such as output channel 350a, buffer inlet 360a, or waste outlet 370a, for inlet, outlet, and waste, respectively. In an example embodiment, each of the bottom layers 320a, 320b comprises a plurality of sorter channels 330.

Whilst the foregoing description has described exemplary embodiments, it will be understood by those skilled in the art that many variations of the embodiments can be made within the scope and spirit of the present invention.

1. A microfluidic system for parallel sample processing, the microfluidic system comprising one or more modules, each module comprising:
one or more microfluidic chips arranged in a microfluidic chip stack,
each of the one or more microfluidic chips comprising a plurality of processing channels, each processing channel comprising an inlet, an outlet, and a processing section,
a combined sample inlet fluidically coupled to each processing channel inlet and configured to concatenate a plurality of the processing channel inlets, and
a combined sample outlet fluidically coupled to each processing channel outlet and configured to concatenate a plurality of the processing channel outlets.

2. The microfluidic system of claim 1, wherein the microfluidic chip stack comprises two or more microfluidic chips, wherein respective processing channel inlets and processing channel outlets of each microfluidic chip are fluidically coupled by respective inlet and outlet through vias traversing the chip stack,
wherein the sample inlet is fluidically coupled to the inlet vias and is configured to concatenate a plurality of the processing channel inlets, and
wherein the sample outlet is fluidically coupled to the outlet vias and is
configured to concatenate a plurality of the processing channel outlets.

3. The microfluidic system of claim 1, wherein the sample inlet and/or the sample outlet are formed as a layer of the microfluidic chip stack, or wherein the sample inlet and/or the sample outlet are formed as a portion or region of one or more of the microfluidic chips arranged in the microfluidic chip stack.

4. The microfluidic system of claim 1, wherein the plurality of processing channels each further comprise a respective washing buffer inlet and/or waste outlet.

5. The microfluidic system of claim 4, further comprising:
a combined wash inlet configured to concatenate the plurality of processing channel washing buffer inlets, and/or
a combined waste outlet configured to concatenate the plurality of processing channel waste outlets.

6. The microfluidic system of claim 5, wherein the combined wash inlet and/or the combined waste outlet are formed as a layer of the microfluidic chip stack, or wherein the combined wash inlet and/or the combined waste outlet are formed as a portion or region of one or more of the microfluidic chips arranged in the microfluidic chip stack.

7. The microfluidic system of claim 1, wherein the processing channels are arranged in parallel and lengthwise along respective microfluidic chips of the one or more microfluidic chips forming the microfluidic chip stack.

8. The microfluidic system of claim 1, wherein the processing section of one or more of the plurality of processing channels comprises a particle sorter section.

9. The microfluidic system of claim 8, wherein the particle sorter sections of the processing channels comprise a micropillar or nanopillar array, and wherein the micropillars or nanopillars are arranged to provide for deterministic lateral displacement microfluidic sorting of particles traversing the processing channel.

10. The microfluidic system of claim 1, further comprising a manifold fluidically coupled to the one or more modules, the manifold configured to supply fluid flow and/or pressure to each module of the one or more modules.

11. The microfluidic system of claim 10, further comprising a microcontroller configured to control the manifold to selectively operate the one or more modules.

12. The microfluidic system of claim 11, further comprising a feedback sensor configured to provide sample process information from an output of the one or more modules to the microcontroller.

13. The microfluidic system of claim 12, wherein the feedback sensor comprises one or more of:
a flow sensor
a flow volume sensor
a pressure sensor
an imaging sensor.

14. The microfluidic system of claim 12, wherein the sample process information comprises one or more of:
flow rate
flow volume
pressure
particle sorting efficiency
particle sorting yield.

15. A method of forming a microfluidic system for parallel sample processing, comprising:
forming a plurality of processing channels in one or more stacked microfluidic chips, the processing channels comprising an inlet, an outlet, and a processing section,
forming a plurality of concatenating sections in either:
one or more of the microfluidic chips forming the microfluidic chip stack, and/or
a separate concatenating layer of the chip stack,
wherein the concatenating sections are configured to fluidly connect inlets and/or outlets of the processing channels.

16. The method of claim 15, further comprising forming respective inlet and outlet through vias in each of the one or more stacked microfluidic chips, the through vias fluidically linked in the chip stack such that the through vias traverse the chip stack and fluidically connect the respective inlets and/or outlets of the processing channels.

17. The method of claim 15, wherein the processing channels further comprise one or more washing buffer inlets and/or waste outlets, and wherein the step of forming a plurality of concatenating sections comprises forming concatenating sections in either:
one or more of the microfluidic chips forming the microfluidic chip stack, and/or
a separate concatenating layer of the chip stack,
wherein the concatenating sections are configured to fluidly connect washing buffer inlets and/or waste outlets of the processing channels.

18. The method of claim 15, wherein the processing channels are formed in parallel and lengthwise along respective microfluidic chips of the one or more stacked microfluidic chips.

19. The method of claim 15, wherein the processing section of one or more of the processing channels comprises a particle sorter section.

20. The method of 19, wherein the particle sorter sections of the processing channels comprise a micropillar or nanopillar array, and wherein the micropillars or nanopillars are arranged to provide for deterministic lateral displacement microfluidic sorting of particles traversing the processing channel.
